(19) United States
(12) Patent Application Publication
(10) Pub. No.: US 2025/0220598 A1
(43) Pub. Date: Jul. 3, 2025

(54) MULTIPLE SYNCHRONIZATION SIGNAL BLOCK PERIODICITIES IN A TIME CYCLE

(71) Applicant: QUALCOMM Incorporated, San Diego, CA (US)

(72) Inventors: Daniel PAZ, Atlit (IL); Michael LEVITSKY, Rehovot (IL); Assaf TOUBOUL, Netanya (IL)

(21) Appl. No.: 18/847,423

(22) PCT Filed: Mar. 14, 2023
(86) PCT No.: PCT/US2023/064322

§ 371 Date: Sep. 16, 2024

(30) Foreign Application Priority Data
May 10, 2022 (IL) 292936

(51) Int. Cl. H04W 56/00; H04L 5/00

(52) U.S. Cl. CPC H04W 56/001; H04L 5/0048

(57) ABSTRACT

Various aspects of the present disclosure generally relate to wireless communication. In some aspects, a user equipment (UE) may receive an indication of a configuration of synchronization signal blocks (SSBs) for a time cycle, the configuration indicating a first SSB periodicity for a first portion of the time cycle and a second SSB periodicity for a second portion of the time cycle. The UE may receive multiple SSBs during the time cycle, the multiple SSBs received with the first SSB periodicity during the first portion of the time cycle and with the second SSB periodicity during the second portion of the time cycle. Numerous other aspects are described.

### CROSS-REFERENCE TO RELATED APPLICATION

This Patent Application claims priority to Israeli Patent Application No. 292936, filed on May 10, 2022, entitled “MULTIPLE SYNCHRONIZATION SIGNAL BLOCK PERIODICITIES IN A TIME CYCLE.” The disclosure of the prior Application is considered part of and is incorporated by reference into this Patent Application.

### FIELD OF THE DISCLOSURE

Aspects of the present disclosure generally relate to wireless communication and to techniques and apparatuses for multiple synchronization signal block periodicities in a time cycle.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication of a configuration of synchronization signal blocks (SSBs) for a time cycle, the configuration indicating a first SSB periodicity for a first portion of the time cycle and a second SSB periodicity for a second portion of the time cycle. The method may include receiving multiple SSBs during the time cycle, the multiple SSBs received with the first SSB periodicity during the first portion of the time cycle and with the second SSB periodicity during the second portion of the time cycle.

Some aspects described herein relate to a method of wireless communication performed by a network node. The method may include transmitting an indication of a configuration of SSBs for a time cycle, the configuration indicating a first synchronization signal block (SSB) periodicity for a first portion of the time cycle and a second SSB periodicity for a second portion of the time cycle. The method may include transmitting multiple SSBs during the time cycle, the multiple SSBs transmitted with the first SSB periodicity during the first portion of the time cycle and with the second SSB periodicity during the second portion of the time cycle.

Some aspects described herein relate to a UE for wireless communication. The user equipment may include a memory and one or more processors coupled to the memory. The one or more processors may be configured to receive an indication of a configuration of SSBs for a time cycle, the configuration indicating a first SSB periodicity for a first portion of the time cycle and a second SSB periodicity for a second portion of the time cycle. The one or more processors may be configured to receive multiple SSBs during the time cycle, the multiple SSBs received with the first SSB periodicity during the first portion of the time cycle and with the second SSB periodicity during the second portion of the time cycle.

Some aspects described herein relate to a network node for wireless communication. The network node may include a memory and one or more processors coupled to the memory. The one or more processors may be configured to transmit an indication of a configuration of SSBs for a time cycle, the configuration indicating a first SSB periodicity for a first portion of the time cycle and a second SSB periodicity for a second portion of the time cycle. The one or more processors may be configured to transmit multiple SSBs during the time cycle, the multiple SSBs transmitted with the first SSB periodicity during the first portion of the time cycle and with the second SSB periodicity during the second portion of the time cycle.

Some aspects described herein relate to a non-transitory computer-readable medium that stores a set of instructions for wireless communication by a UE. The set of instructions, when executed by one or more processors of the UE, may cause the UE to receive an indication of a configuration of SSBs for a time cycle, the configuration indicating a first SSB periodicity for a first portion of the time cycle and a second SSB periodicity for a second portion of the time cycle. The set of instructions, when executed by one or more processors of the UE, may cause the UE to receive multiple SSBs during the time cycle, the multiple SSBs received with the first SSB periodicity during the first portion of the time cycle and with the second SSB periodicity during the second portion of the time cycle.

Some aspects described herein relate to a non-transitory computer-readable medium that stores a set of instructions for wireless communication by a network node. The set of instructions, when executed by one or more processors of the network node, may cause the network node to transmit an indication of a configuration of SSBs for a time cycle, the configuration indicating a first SSB periodicity for a first portion of the time cycle and a second SSB periodicity for a second portion of the time cycle. The set of instructions, when executed by one or more processors of the network node, may cause the network node to transmit multiple SSBs during the time cycle, the multiple SSBs transmitted with the first SSB periodicity during the first portion of the time cycle and with the second SSB periodicity during the second portion of the time cycle.

Some aspects described herein relate to an apparatus for wireless communication. The apparatus may include means for receiving an indication of a configuration of SSBs for a time cycle, the configuration indicating a first SSB periodicity for a first portion of the time cycle and a second SSB periodicity for a second portion of the time cycle. The apparatus may include means for receiving multiple SSBs during the time cycle, the multiple SSBs received with the first SSB periodicity during the first portion of the time cycle and with the second SSB periodicity during the second portion of the time cycle.

Some aspects described herein relate to an apparatus for wireless communication. The apparatus may include means for transmitting an indication of a configuration of SSBs for a time cycle, the configuration indicating a first SSB periodicity for a first portion of the time cycle and a second SSB periodicity for a second portion of the time cycle. The apparatus may include means for transmitting multiple SSBs during the time cycle, the multiple SSBs transmitted with the first SSB periodicity during the first portion of the time cycle and with the second SSB periodicity during the second portion of the time cycle.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples. those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIGS. 4A and 4B are diagrams illustrating examples of synchronization signal block (SSB) broadcasting, in accordance with the present disclosure.

FIGS. 5-7 are diagrams illustrating examples associated with using multiple synchronization signal block periodicities in a time cycle, in accordance with the present disclosure.

FIGS. 8 and 9 are diagrams illustrating example processes associated with using multiple synchronization signal block periodicities in a time cycle, in accordance with the present disclosure.

FIGS. 10 and 11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

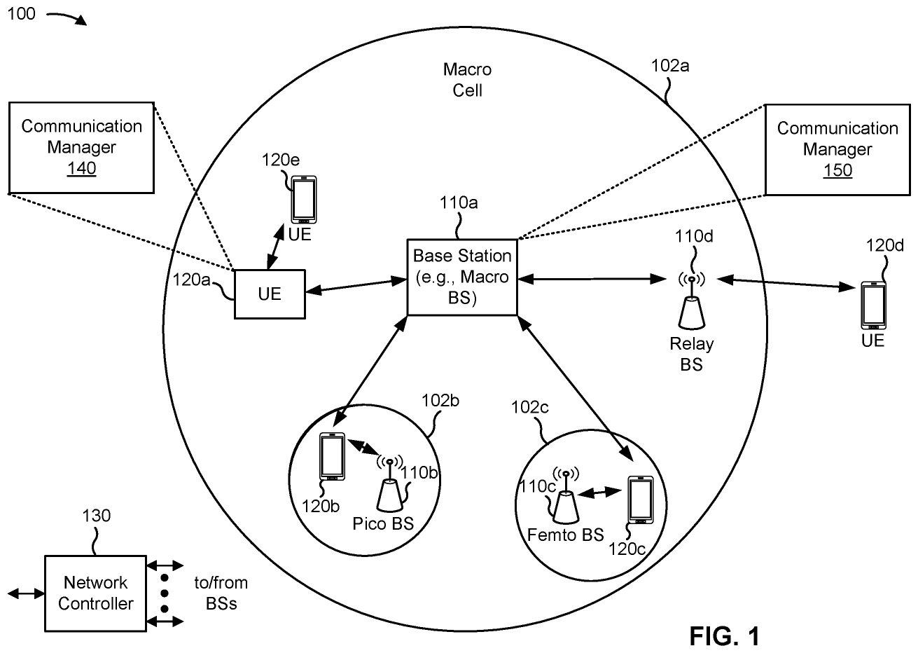

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120c), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2. which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of a configuration of SSBs for a time cycle, the configuration indicating a first SSB periodicity for a first portion of the time cycle and a second SSB periodicity for a second portion of the time cycle; and receive multiple SSBs during the time cycle, the multiple SSBs received with the first SSB periodicity during the first portion of the time cycle and with the second SSB periodicity during the second portion of the time cycle. Additionally, or alternatively, the communication manager 140 may perform one or more other operations described herein.

In some aspects, the network node may include a communication manager 150. As described in more detail elsewhere herein, the communication manager 150 may transmit an indication of a configuration of SSBs for a time cycle, the configuration indicating a first SSB periodicity for a first portion of the time cycle and a second SSB periodicity for a second portion of the time cycle; and transmit multiple SSBs during the time cycle, the multiple SSBs transmitted with the first SSB periodicity during the first portion of the time cycle and with the second SSB periodicity during the second portion of the time cycle. Additionally, or alternatively, the communication manager 150 may perform one or more other operations described herein.

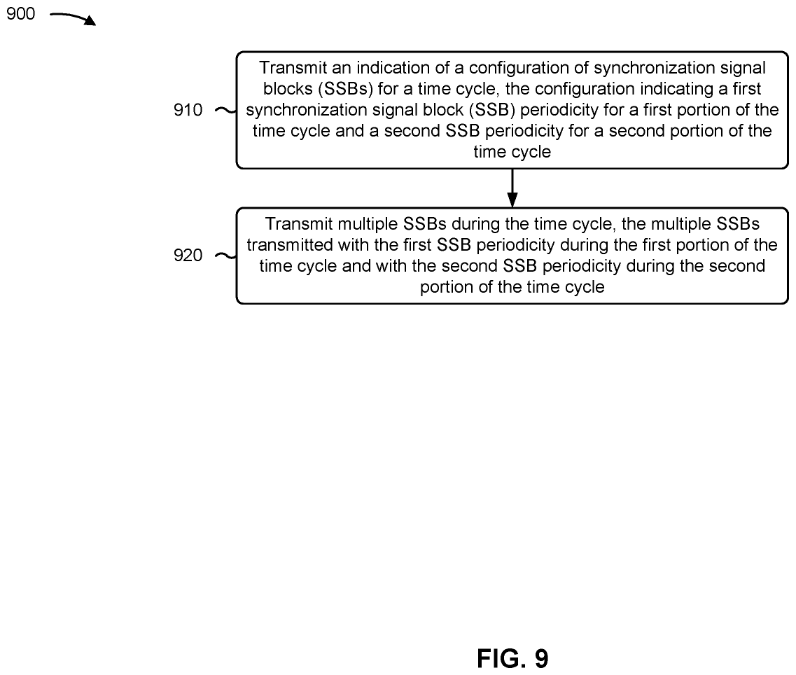

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

As indicated above, FIG. 1 is provided as an example. Other examples may differ from what is described with regard to FIG. 1.

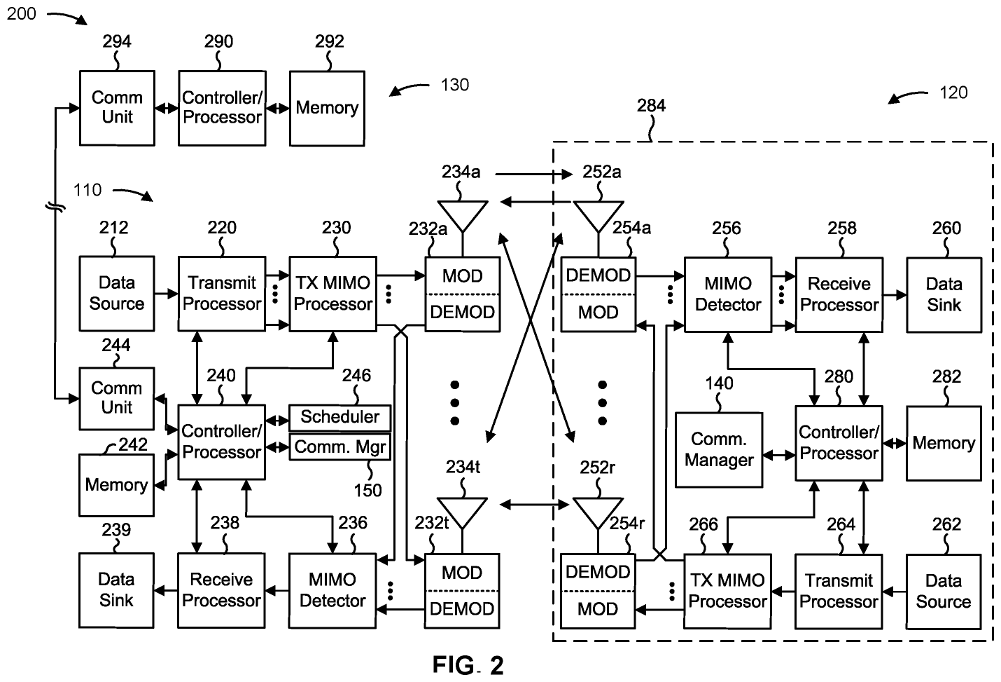

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

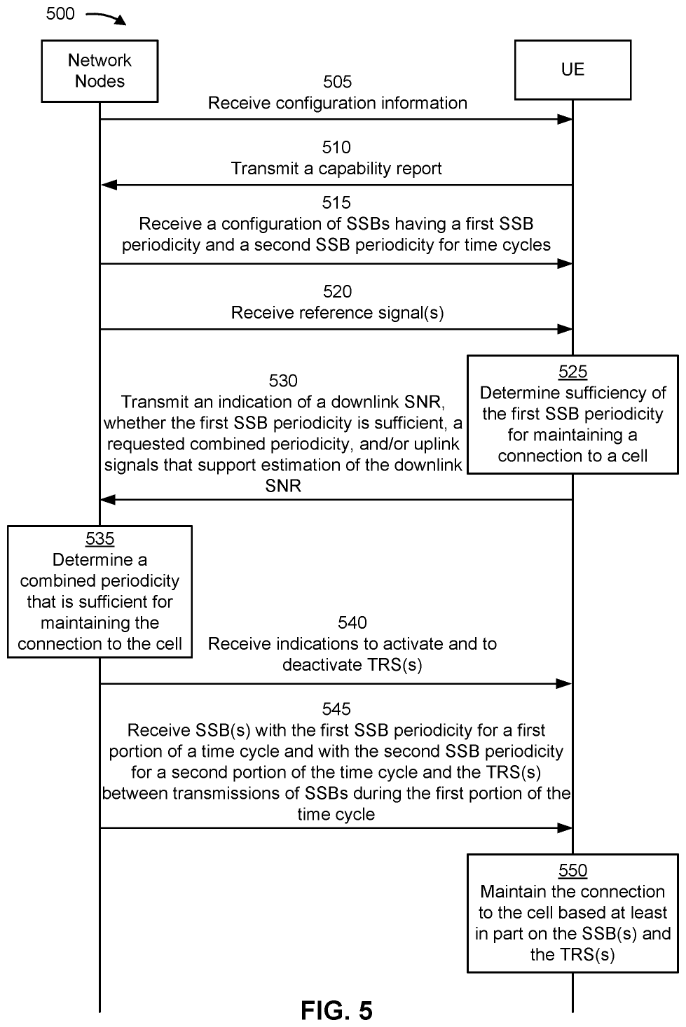

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-11).

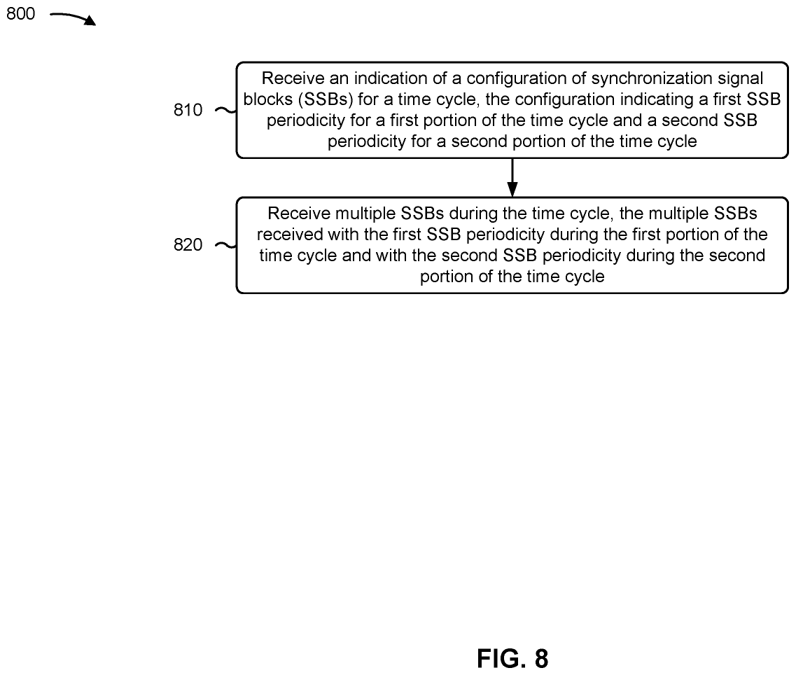

The controller/processor 240 of the base station 110, the controller/processor 280 of the UE 120, and/or any other component(s) of FIG. 2 may perform one or more techniques associated with using multiple synchronization signal block periodicities in a time cycle, as described in more detail elsewhere herein. In some aspects, the network node described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE includes means for receiving an indication of a configuration of SSBs for a time cycle, the configuration indicating a first SSB periodicity for a first portion of the time cycle and a second SSB periodicity for a second portion of the time cycle; and/or means for receiving multiple SSBs during the time cycle, the multiple SSBs received with the first SSB periodicity during the first portion of the time cycle and with the second SSB periodicity during the second portion of the time cycle. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting an indication of a configuration of SSBs for a time cycle, the configuration indicating a first SSB periodicity for a first portion of the time cycle and a second SSB periodicity for a second portion of the time cycle; and/or means for transmitting multiple SSBs during the time cycle, the multiple SSBs transmitted with the first SSB periodicity during the first portion of the time cycle and with the second SSB periodicity during the second portion of the time cycle. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

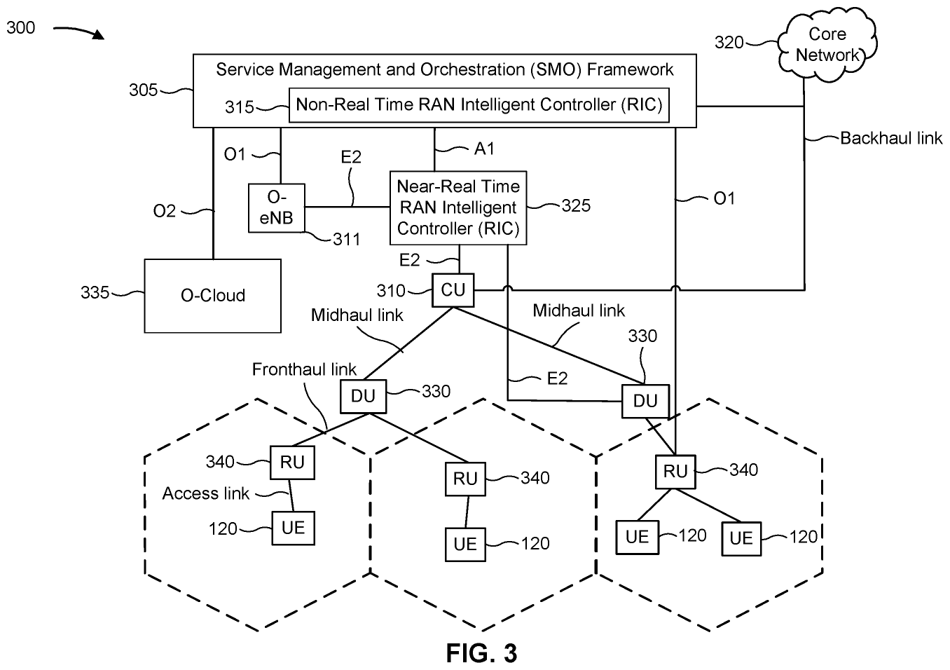

FIG. 3 is a diagram illustrating an example 300 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-Real Time (Near-RT) RIC 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary. for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 335) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311. via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

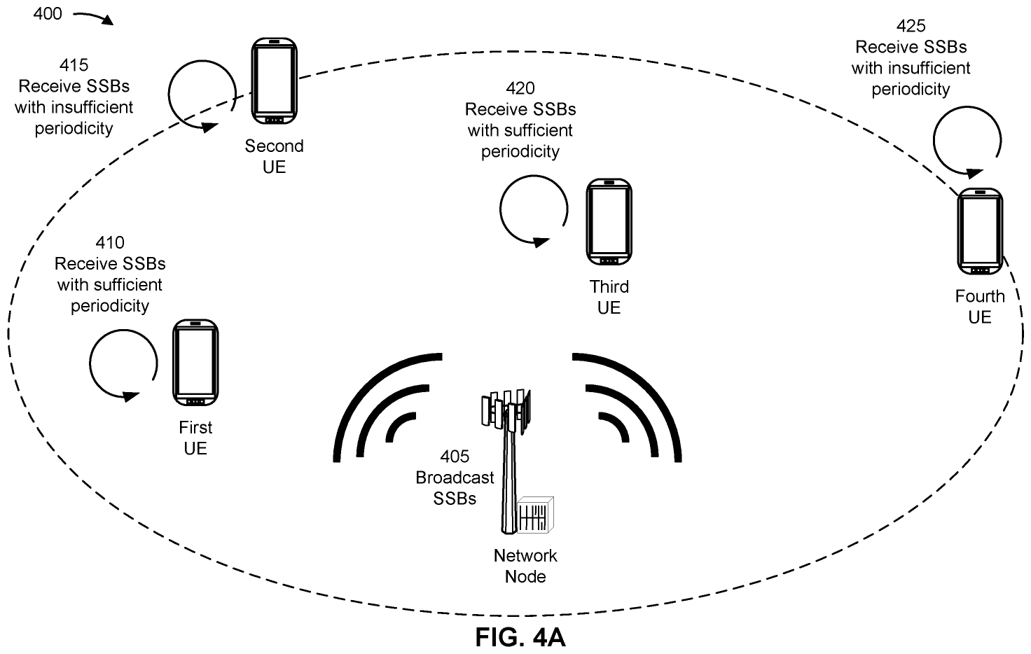

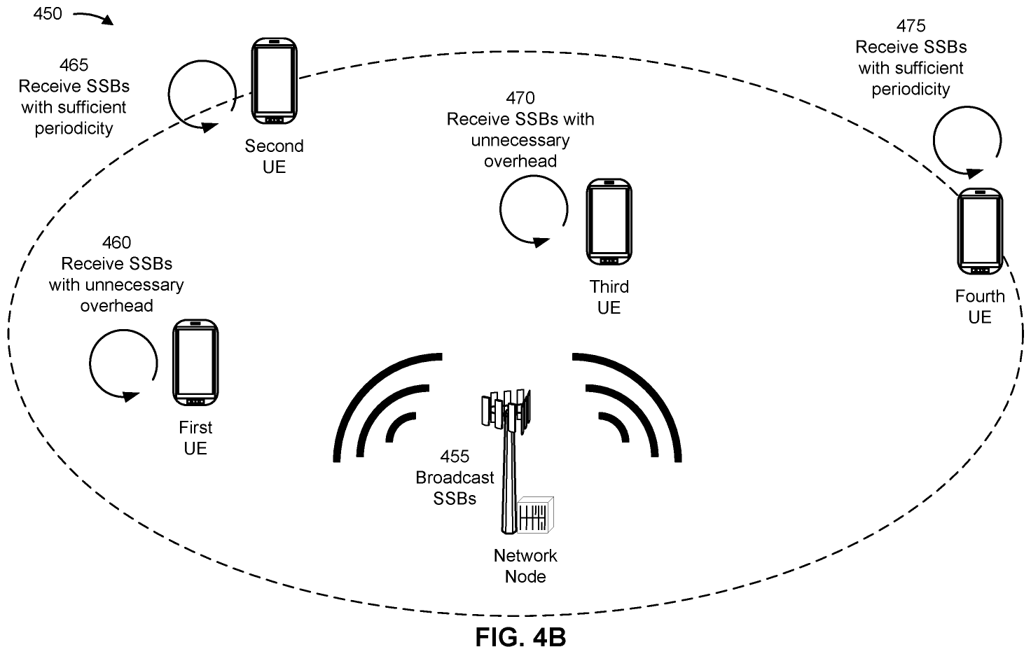

FIGS. 4A and 4B are diagrams illustrating examples 400 and 450 of SSB broadcasting, in accordance with the present disclosure. In some networks, a network node may be configured to provide a cell of a network (e.g., provide connection to the network to devices with the cell). The network node may be configured to provide SSBs to support connections within the cell. For example, the network node may provide SSBs to support acquisition of the cell (e.g., initial acquisition), synchronization (e.g., frequency synchronization and/or time synchronization, among other examples), and/or beam management, among other examples.

As shown in FIG. 4A, and by reference number 405, a network node may broadcast SSBs within the cell. The SSBs may have a relatively high periodicity to conserve network resources (e.g., overhead). For example, the SSBs may have a periodicity of 40 milliseconds or more.

As shown by reference number 410, a first UE may receive the SSBs with sufficient periodicity to maintain a connection with the cell. For example, the SSBs may have a periodicity that supports frequency synchronization, time synchronization, and/or beam management for the first UE. The periodicity of the SSBs may be sufficient based at least in part on the UE having a signal-to-noise ratio (SNR) and/or a signal-to-interference-plus-noise ratio (SINR) that satisfies a threshold.

As shown by reference number 415, a second UE may receive the SSBs with insufficient periodicity to maintain a connection with the cell. For example, the SSBs may not have a periodicity that supports frequency synchronization, time synchronization, and/or beam management for the second UE. The periodicity of the SSBs may be insufficient based at least in part on the UE having an SNR and/or an SINR that fails to satisfy a threshold.

Similarly, as shown by reference number 420, a third UE may receive the SSBs with sufficient periodicity to maintain a connection with the cell. As shown by reference number 425, a fourth UE may receive the SSBs with insufficient periodicity to maintain a connection with the cell.

In example 400, the periodicity of the SSBs may prioritize spectral efficiency (e.g., reduction in overhead) over supporting connections for UEs at the cell edge. In this case, network, communication, power, and/or computing resources are unnecessarily consumed to attempt to reestablish connections with UEs at the cell edge.

As shown in FIG. 4B, and by reference number 455, a network node may broadcast SSBs within the cell. The SSBs may have a relatively low periodicity (e.g., in comparison with a periodicity shown in FIG. 4A) to support maintenance of connection to the cell for UEs at a cell edge. However, the periodicity may unnecessarily consume network resources (e.g., create unnecessary overhead) for UEs with signal strengths (e.g., SNRs or SINRs) that satisfy a threshold. For example, the SSBs may have a periodicity of 40 milliseconds or less.

As shown by reference number 460, a first UE may receive the SSBs with sufficient periodicity to maintain a connection with the cell, but with unnecessary overhead. For example, the SSBs may have a periodicity that is more than necessary to support frequency synchronization, time synchronization, and/or beam management for the first UE. The periodicity of the SSBs may be more than sufficient based at least in part on the UE having an SNR and/or an SINR that satisfies a threshold.

As shown by reference number 465, a second UE may receive the SSBs with a sufficient periodicity to maintain a connection with the cell (e.g., without unnecessary overhead). For example, the SSBs may have a periodicity that supports frequency synchronization, time synchronization, and/or beam management for the second UE. The periodicity of the SSBs may be sufficient based at least in part on the UE having an SNR and/or an SINR that satisfies a threshold and/or based at least in part on the periodicity being configured for UEs at the cell edge.

Similarly, as shown by reference number 470, a third UE may receive the SSBs with sufficient periodicity to maintain a connection with the cell, but with unnecessary overhead. As shown by reference number 475, a fourth UE may receive the SSBs with sufficient periodicity to maintain a connection with the cell.

In example 450, the periodicity of the SSBs may prioritize supporting connections for UEs at the cell edge over spectral efficiency. In this case, network, communication, power, and/or computing resources are unnecessarily consumed to support connections at the cell edge.

As indicated above, FIGS. 4A and 4B are provided as examples. Other examples may differ from what is described with regard to FIGS. 4A and 4B.

In some networks, such as high-frequency networks (e.g., sub-terahertz (SubThz) frequency networks, among other examples), a relatively low SSB periodicity (e.g., relatively high density) may be required for initial acquisition and initial synchronization loops convergence and steady state synchronization loops tracking (e.g., compared to other frequency bands). This may be based at least in part on SubThz having an increased sensitivity to timing drift and/or parts per million (ppm) error (e.g., due to a lower numerology) and/or a degraded accuracy of frequency offset (FO)/ppm error estimation from another other side (smaller observation time for FO estimation based at least in part on a single SSB and an increased phase-noise-related variance of FO/ppm error estimation). Correspondingly, a lower SSB periodicity may be required to allow a required rate of loop updates in order to achieve initial convergence and a required level of residual frequency and timing errors at loop output to reach a steady state. This may be especially challenging during an initial convergence at a lowest edge of a targeted SNR range.

Additionally, or alternatively, non-coherent combining of SSB detection peaks across several SSBs may be required for initial acquisition (InitAcq to support sufficient coverage characteristics (e.g., detection at a lowest targeted negative SNR). Additionally, a time gap between consecutive SSBs (an SSB period) that are used for detection peaks combining should be smaller (e.g., compared to other bands) because of timing-drift-related sensitivity and uncertainty.

During a connected mode, a frequency and/or time synchronization may be maintained based at least in part on SSBs and/or other reference signals (RSs), such as tracking reference signals (TRSs), phase tracking reference signals (PT-RSs), and/or DMRS. Based at least in part on substituting the other RSs to maintain the frequency and/or time synchronization, SSB periodicity during this time may be less critical. For connected UEs having an SNR that satisfies a threshold, synchronization loop update rates may be lower, such that different synchronization RS rates may be required for different connected UEs depending on their SNR.

Because SSBs are broadcasted signals, SSBs may be configured to target supporting UEs in worst-case conditions (e.g., cell edge UEs), and a corresponding minimal SSB periodicity should be employed to guarantee that these cell edge UEs residing at the targeted cell edge can be served.

However, a higher SSB periodicity may be sufficient for synchronization loop maintenance for UEs that are experiencing a relatively high SNR (e.g., SNRs that satisfy a threshold) or for UEs already residing in synchronization conditions and/or a steady state (e.g., post InitAcq and initial convergence of synchronization loops). This may apply for SubThz systems, where a main sensitivity for synchronization may be based at least in part on time synchronization due to higher numerology and a smaller cyclic prefix duration. Residual ppm error and a corresponding time drift for the latter category of UEs (e.g., UEs with SNRs greater than a threshold or UEs that are already in synchronization condition) are limited, such that an affordable time gap between consecutive occurrences of the same SSB can be higher while still supporting synchronization and/or maintaining a connection to the cell.

In some aspects described herein, a time cycle associated with SSBs may be configured with a first portion having SSBs at a first SSB periodicity and a second portion having SSBs at a second SSB periodicity. The first SSB periodicity may be configured to support maintenance of a connection to a cell for UEs having SNRs that satisfy a threshold. However, for UEs having SNRs that fail to satisfy the threshold, a network node may transmit additional RSs to supplement the SSBs in the first portion. For example, the network node may transmit UE-specific TRSs to UEs that report or otherwise indicate SNRs that fail to satisfy the threshold. In this way, a combined periodicity of the SSBs and the RSs may be sufficient to maintain a connection to the cell for UEs having SNRs that fail to satisfy the threshold. In some aspects, the second periodicity may be configured to support acquisition of the cell by, for example, UEs at a cell edge (e.g., a cell edge). In this way, a UE in the cell can use SSBs transmitted within the second portion of the time cycle to acquire the cell and, once connected. UEs may use SSBs and/or additional RSs to maintain a connection to the cell during the first portion of the time cycle.

Based at least in part on using SSBs with variable periodicities (e.g., with the time cycle having a first SSB periodicity in the first portion and a second SSB periodicity in the second portion), the network node may reduce overhead generally for transmitting SSBs during the first portion and may increase overhead for specific UEs when necessary to maintain the connection to the cell.

Overall, using a variable SSB periodicity coupled to a complementary and adaptively allocated UE-specific TRSs may support a reduced, but still effective, synchronization pilot overhead (e.g., associated with the SSBs and TRSs) in the network. Additionally, or alternatively, the variable periodicity SSBs with variable periodicity complementary UE-specific TRSs may support an additional reduction of synchronization RS overhead (e.g., in addition to what can be achieved with UE-specific TRS having a constant periodicity).

Minimization of a rate of synchronization RS transmissions (e.g., adaptive to UE SNR and/or other network conditions) may also support a reduced power consumption by the network node for a SubThz application. For example, the reduce power consumption for the network node may be based at least in part on reducing always on broadcast transmissions and/or by configuring longer time gaps between the broadcast transmissions, which may support an increase of opportunities for potential sleep periods for the network node.

To apply variable SSB periodicity, a time cycle may be defined. The time cycle may include a repeating configuration for transmitting SSBs and/or TRSs. The time cycle of K slots/T (e.g., in milliseconds (ms)). For X% of the time cycle, an SSB periodicity is set to be N (ms), where N is a periodicity required for InitAcq and initial synchronization loop convergence for cell edge UEs. X% will be set according to a time window required for InitAcq+beam search, and initial sync loops convergence for cell edge UEs. For a remainder of the time cycle (100−X)%, the SSB periodicity is set to be M (ms) (e.g., where M=N*C and C is an integer). M is a periodicity required for automatic gain control (AGC) tracking, maintenance of synchronization loops, and maintain beam management of UEs residing in SNR conditions that satisfy a threshold (THR).

UEs experiencing SNR<THR, which are unable to maintain synchronization loops and AGC tracking with the minimum required level of accuracy with SSB periodicity M, may require a complementary UE-specific TRS during (100−X)% of the time cycle, where SSB periodicity for these UEs is too high.

The TRS pattern (e.g., an allocation in time and frequency) and TRS periodicity during the time cycle (K slots) may be dynamically adopted, reconfigured, and/or signaled such that an effective combined RS periodicity for tracking loops of a specific UE (SSB+UE specific TRS) may not be higher than a required minimum effective synchronization RS periodicity for a targeted level of accuracy of all the tracking loops at SNR experienced by the UE. Correspondingly, during (100−X)% of the time cycle, where SSB periodicity is too high for this UE to keep the required level of synchronization, an adjustable UE specific TRS periodicity will be equal to or lower than a required minimum effective pilot RS period time L (ms) for SNR conditions experienced by the UE (where N≤L<M).

UE-specific TRSs may be active during (100−X)% of the time cycle for UEs having SNR<THR. This may require dynamic activation/deactivation of UE-specific TRSs for different parts of time cycle (having K slots duration).

The TRS pattern (e.g., at least TRS periodicity) during TRS active time may be dynamically adopted as a function of a UE SNR. Variable TRS periodicity per UE and/or per UE SNR may be achieved via dynamic reconfiguration of UE specific TRSs.

L may not be equal to N assuming that a specific UE is not a cell edge UE, but L may be required to be lower than M (e.g., because SSB period time M is insufficient for proper synchronization loops tracking of a UE having SNR<THR).

In some aspects, after InitAcq, connected UEs may receive, from the network (e.g., from a network node) all required information to be aware of variable SSB periodicities M and N and corresponding time boundaries for a serving cell. For example, the UEs may receive this information via a master information block (MIB) or system information block (SIB).

The UE-specific TRS may be allocated adaptively and dynamically by the network to be complementary to SSBs for UEs with poor reception conditions to comply with sync requirements (e.g., for cell edge UEs or UEs with SNR<THR, where the THR is associated with and/or assumed by the network node for defining the higher SSB periodicity among the two alternated SSB periodicities).

The network may evaluate which UEs should be allocated with TRS, a required TRS periodicity (e.g., below some maximum time) per UE depending on its SNR, and/or time boundaries for active TRS transmission that will have the TRS pattern across the time cycle (K slots), which may result in a new effective tracking loops pilot periodicity I, per UE based on its SNR.

UE SNR in downlink may be reported by a UE or evaluated by a network node based on uplink measurements or can be estimated (e.g., derived) based at least in part on an operational modulation and coding scheme (MCS) for downlink. In some aspects, the network node may evaluate the UE SNR in downlink based at least in part on random access channel (RACH) reception before finalizing a UE transition to a connected mode.

In some aspects, different time (e.g., intra-slot or inter-slot) and/or different frequency TRS patterns may be dynamically configured and/or reconfigured per UE.

To achieve variable TRS periodicity complementary to an SSB pattern, only dynamic TRS activation and/or deactivation per UE along with a reconfigurable periodicity per activation may be required. These capabilities may be enabled by an adaptive UE-specific TRS approach.

Assuming SSB and TRS superposition, at least the following effective synchronization pilot periodicities may be obtained: 5 ms, 10 ms, 20 ms, and 40 ms. In some aspects, additional TRS periodicity options may include 80 ms or 160 ms to generate an effective synchronization pilot periodicity of 40 ms or 80 ms.

Based at least in part on configuring SSBs for a time cycle having a first portion with SSBs at a first SSB periodicity and a second portion with SSBs at a second SSB periodicity, a network node and one or more UEs may conserve network, power, communication, and/or computing resources that may have otherwise been used to receive SSBs with an unnecessarily low periodicity (unnecessarily high density) that reduces spectral efficiency and requires an unnecessary amount of resources to communicate a same amount of data. Additionally, or alternatively, configuring SSBs for a time cycle having a first portion with SSBs at a first SSB periodicity and a second portion with SSBs at a second SSB periodicity, a network node and one or more UEs may conserve network, power, communication, and/or computing resources that may have otherwise been used to attempt connections and reconnection with UEs at a cell edge for which an SSB periodicity is too large to maintain a connection.

Based at least in part on using TRSs to supplement an SSB periodicity during a portion of a time cycle having too high of a periodicity for one or more UEs to maintain a connection to the cell, a network node and one or more UEs may conserve network, power, communication, and/or computing resources that may have otherwise been used to transmit and receive SSBs with a periodicity during the portion of the time cycle that is configured for all UEs in the cell (e.g., too large for some UEs and/or too small for other UEs).

FIG. 5 is a diagram of an example 500 associated with using multiple SSB periodicities in a time cycle, in accordance with the present disclosure. As shown in FIG. 5, a network node (e.g., base station 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 5. In some aspects, the UE may be one of a number of UEs within a cell provided by the network node. In some aspects, the network node may be configured to provide the cell for a geographical area and/or for a defined distance from the network node.

As shown by reference number 505, the network node may transmit, and the UE may receive, configuration information. In some aspects, the UE may receive the configuration information via one or more of RRC signaling, one or more MAC control elements (CEs), and/or downlink control information (DCI), among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to use RSs, such as TRSs to supplement SSBs to maintain a connection to the cell. For example, the configuration information may indicate that the UE is to use TRSs and SSBs to perform frequency synchronization, time synchronization, and/or beam management. In some aspects, the configuration information may indicate that the UE is to transmit an indication of a signal strength (e.g., SNR, RSRP, or SINR), an indication of a requested combined periodicity of the RSs and SSBs to maintain a connection to the cell, and/or one or more signals for the base station to measure to determine the signal strength and/or an estimated required combined periodicity of the RSs and the SSBs to maintain the connection to the cell, among other examples.

The UE may configure itself based at least in part on the configuration information. In some aspects, the UE may be configured to perform one or more operations described herein based at least in part on the configuration information.

As shown by reference number 510, the UE may transmit, and the network node may receive, a capabilities report. In some aspects, the capabilities report may indicate UE support for receiving SSBs with variable periodicities. In some aspects, the capabilities report may indicate support for using RSs (e.g., TRSs) to supplement SSBs to maintain a connection to the cell. For example, the capabilities report may indicate a type of RS that the UE can use to supplements the SSBs, an amount of time needed for cell acquisition, and amount of time needed for operations associated with maintaining the connection to the cell, and/or a combined periodicity needed for the operations associated with maintaining the connection to the cell.

As shown by reference number 515, the UE may receive, and the network node may transmit, a configuration of SSBs having a first SSB periodicity and a second SSB periodicity for time cycles. For example, the UE may receive an indication of a configuration of SSBs for a time cycle, the configuration indicating a first SSB periodicity for a first portion of the time cycle and a second SSB periodicity for a second portion of the time cycle.

In some aspects, the configuration of SSBs may indicate that for each time cycle (e.g., for a number of cycles, an amount of time, or until the network node provides an update, among other examples), a first portion of the time cycle is configured with the first SSB periodicity and a second portion of the time cycle is configured with the second SSB periodicity. In some aspects, the first SSB periodicity is a multiple of the second SSB periodicity (e.g., the first SSB periodicity is 2×, 3×, or 4× the second SSB periodicity, among other examples).

In some aspects, the second SSB periodicity may be configured to support InitAcq (e.g., cell acquisition) for UEs at a cell edge. For example, the network node may be configured to support UEs that are in a defined geographical boundary or that are within a threshold distance from the network node. The network node may be configured with, or may use machine learning to obtain, the second SSB periodicity that supports InitAcq for the UEs at the cell edge (e.g., at a location of the cell with a weakest signal strength).

In some aspects, the first SSB periodicity may be configured to support maintenance of the cell for UEs with a signal strength that satisfies a threshold (e.g., SNR>THR). In this way, the network node may not support maintenance of the cell for all UEs within the cell using only SSBs during the first portion of the time cycle.

As shown by reference number 520, the UE may receive one or more RSs. For example, the UE may measure the one or more RSs to determine a signal strength of the cell at the UE for downlink communications. The signal strength may include a measured or estimated RSRP, SNR, or SINR, among other examples.

As shown by reference number 525, the UE may determine sufficiency of the first SSB periodicity for maintaining the connection to the cell. For example, the UE may test the first SSB periodicity or may use the signal strength of the RSs to determine whether the first SSB periodicity is sufficient for the UE to maintain the connection to the cell. For example, the UE may determine if the first SSB periodicity is sufficient to perform time synchronization, frequency synchronization, and/or beam management to maintain the connection to the cell.

As shown by reference number 530, the UE may transmit, and the base station may receive, an indication of a downlink SNR, whether the first SSB periodicity is sufficient, a requested combined periodicity, and/or uplink signals that support estimation of the downlink SNR, among other examples. For example, the UE may first determine the sufficiency of the first SSB periodicity, as described in connection with reference number 525, and then transmit an indication of whether the SSB periodicity is sufficient and/or transmit a requested combined periodicity (e.g., a combined periodicity of RSs and SSBs). In other examples, the UE may not determine sufficiency of the first SSB periodicity (e.g., operations described in connection with reference number 525 may be omitted) and the UE may transmit an indication of a downlink SNR and/or uplink signals that the network node may use to determine and/or estimate the downlink SNR. The indication of the downlink SNR and/or the uplink signals may support a determination by the network node of whether the first SSB periodicity is sufficient for the UE and/or a combined periodicity that would be sufficient for the UE.

In some aspects, the indication of the SNR and/or the determined and/or estimated SNR may indicate that the first SSB periodicity is insufficient for maintaining the connection to the cell.

As shown by reference number 535, the network node may determine a combined periodicity that is sufficient for maintaining the connection to the cell for the UE. In some aspects, the network node may determine the combined periodicity to require only SSBs during the first portion of the time cycle. In some aspects, the network node may determine the combined periodicity to require SSBs and TRSs during the first portion of the time cycle based at least in part on the first SSB periodicity.

In some aspects, the network node may determine the combined periodicity based at least in part on the indication of a downlink SNR, whether the first SSB periodicity is sufficient, the requested combined periodicity, and/or the uplink signals that support estimation of the downlink SNR described in connection with reference number 535. In some aspects, the network node may use a configured MCS used in downlink communications that satisfies an error rate threshold. For example, the network node may estimate a downlink SNR based at least in part on an MCS that is used for downlink communications without incurring excessive errors.

In some aspects, the network node may identify one or more UEs, including or excluding the UE shown in FIG. 5, for which the first SSB periodicity is insufficient for maintaining a connection to a cell associated with the network node. For example, the network node may receive one or more indications of downlink SNRs from the one or more UEs with identification of the one or more UEs for which the first SSB periodicity is insufficient being based at least in part on the one or more indications of the SNRs from the one or more UEs. In some aspects, the network node may estimate the SNRs based at least in part on one or more of uplink signals received from the one or more UEs or operational parameters for downlink communications, with identification of the one or more UEs for which the first SSB periodicity is insufficient being based at least in part on the estimated SNRs. In some aspects, the network node may configure combined periodicities of the multiple SSBs and the TRSs during the first portion of the time cycle to support timing synchronization or frequency synchronization for the UEs for which the first SSB periodicity is insufficient.

As shown by reference number 540, the UE may receive, and the network node may transmit, indications to activate and deactivate one or more TRSs. For example, the UE may receive an indication to activate the TRSs as periodic RSs during the first portion of the time cycle. The UE may also receive an indication to deactivate the TRSs after the first portion of the time cycle (e.g., before starting the second portion of the time cycle) so the TRSs are deactivated during the second portion. In some aspects, the periodicity of the TRSs may be configured as 160 ms, 80 ms, 40 ms, 20 ms, or 10 ms, among other examples. In some aspects, the UE may an additional indication to deactivate the TRSs to avoid an overlap with an SSB during the first period. The UE may also receive an additional indication to activate the TRSs after the SSB during the first period.

In some aspects, the network node may configure the TRSs to have a combined periodicity with the one or more SSBs to support UEs (e.g., at a cell edge) to synchronize timing with the cell, synchronize frequencies with the cell, and/or perform beam management, among other examples.

In some aspects, the TRSs may be UE-specific TRSs. In this way, the UE may have a different TRS configuration than another UE in the cell. For example, a periodicity of the UE-specific TRSs may be greater than a periodicity of UE-specific TRSs for an additional UE in the cell based at least in part on a signal strength at the UE being greater than a signal strength at the additional UE. Additionally, or alternatively, the UE-specific TRSs may be greater than a periodicity of UE-specific TRSs for an additional UE in the cell based at least in part on capabilities of the UE and the additional UE (e.g., the UE may have a capability to maintain the connection to the cell with a lower SNR).

In some aspects, the UE may receive the indications to activate and to deactivate the TRSs based at least in part on the UE having an SNR or other signal strength metric that fails to satisfy a threshold. In some aspects, a periodicity of the TRSs may be based at least in part on the SNR, another signal strength metric, channel characteristics of a channel associated with the TRSs, a capability of the UE, and/or one or more scheduling constraints at the network node.

As shown by reference number 545, the UE may receive, and the network node may transmit, one or more SSBs with the first SSB periodicity for a first portion of a time cycle and with the second SSB periodicity for a second portion of the time cycle and the one or more TRSs between transmissions of SSBs during the first portion of the time cycle. In some aspects, the TRSs or other RSs may be configured for timing synchronization, frequency synchronization, and/or beam management, among other examples. For example, the TRSs or other RSs may span a bandwidth and/or a time resource to support timing synchronization, frequency synchronization, and/or beam management, among other examples.

In some aspects, the UE may receive the indication to activate and to deactivate the one or more TRSs during the first portion of the time cycle and/or during the second portion of the time cycle.

In some aspects, the UE may receive additional SSB and TRSs during a subsequent time cycle, with the configuration (e.g., associated with the SSBs) for the time cycle being a same configuration as the subsequent time cycle. For example, the UE may receive multiple additional SSBs during the subsequent time cycle, with the multiple additional SSBs received with the first SSB periodicity during a first portion of the subsequent time cycle and with the second SSB periodicity during a second portion of the subsequent time cycle.

As shown by reference number 550, the UE may maintain the connection to the cell based at least in part on the one or more SSBs and the one or more TRSs. For example, the UE may use the one or more SSBs and the one or more TRSs to synchronize timing with the cell, synchronize frequencies with the cell, and/or perform beam management, among other examples.

Based at least in part on configuring SSBs for a time cycle having a first portion with SSBs at a first SSB periodicity and a second portion with SSBs at a second SSB periodicity, a network node and one or more UEs may conserve network, power, communication, and/or computing resources that may have otherwise been used to receive SSBs with an unnecessarily low periodicity (unnecessarily high density) that reduces spectral efficiency and requires an unnecessary amount of resources to communicate a same amount of data. Additionally, or alternatively, configuring SSBs for a time cycle having a first portion with SSBs at a first SSB periodicity and a second portion with SSBs at a second SSB periodicity, a network node and one or more UEs may conserve network, power, communication, and/or computing resources that may have otherwise been used to attempt connections and reconnection with UEs at a cell edge for which an SSB periodicity is too large to maintain a connection.

Based at least in part on using TRSs to supplement an SSB periodicity during a portion of a time cycle having too high of a periodicity for one or more UEs to maintain a connection to the cell, a network node and one or more UEs may conserve network, power, communication, and/or computing resources that may have otherwise been used to transmit and receive SSBs with a periodicity during the portion of the time cycle that is configured for all UEs in the cell (e.g., too large for some UEs and/or too small for other UEs).

As indicated above, FIG. 5 is provided as an example. Other examples may differ from what is described with respect to FIG. 5.

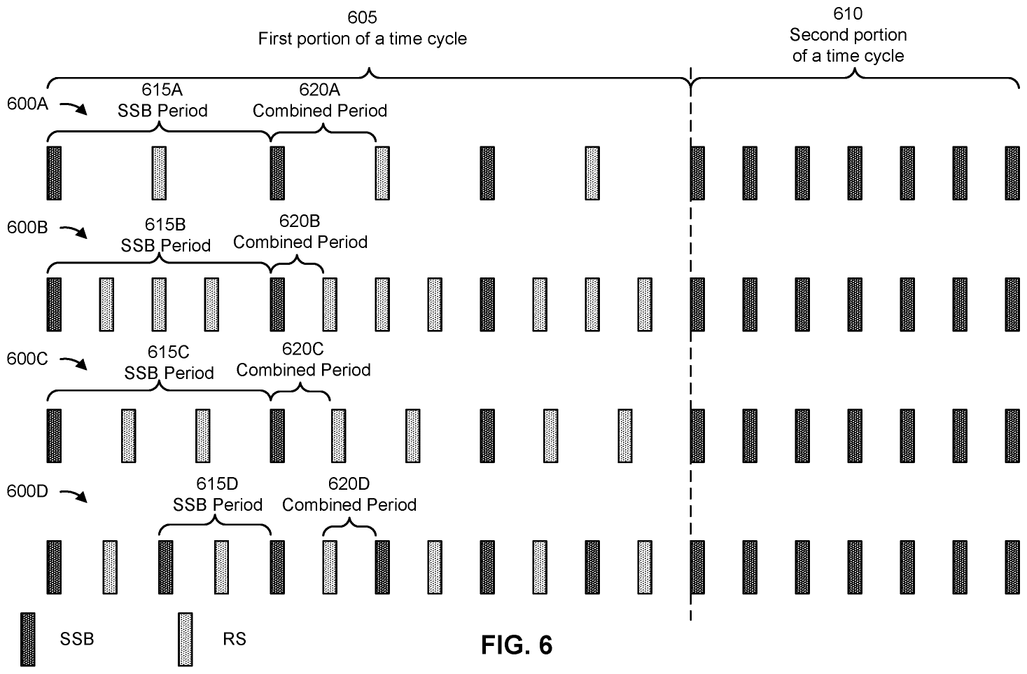

FIG. 6 is a diagram of examples 600A, 600B, 600C, and 600D associated with using multiple SSB periodicities in a time cycle, in accordance with the present disclosure. In example FIG. 6, a network node (e.g., base station 110, a CU, a DU, and/or an RU) may communicate with a UE (e.g., UE 120) using a configuration of SSBs that includes a first portion having a first SSB periodicity and a second portion having a second SSB periodicity. The network node may transmit RSs between SSBs to supplement the SSBs and form a combined periodicity that is less than the first SSB periodicity. The network node may transmit SSBs and RSs within a first portion 605 of the time cycle and within a second portion 610 of the time cycle. In some aspects, the network node and the UE may be part of a wireless network (e.g., wireless network 100). The UE and the network node may have established a wireless connection prior to operations shown in FIG. 6. In some aspects, the UE may be one of a number of UEs within a cell provided by the network node. In some aspects, the network node may be configured to provide the cell for a geographical area and/or for a defined distance from the network node.

As shown in example 600A, the network node may transmit the SSBs with an SSB period 615A and with a combined period 620A that includes the SSBs and RSs transmitted between the SSBs. The SSB period 615A may be 4× an SSB period during the second portion of the time cycle. In this way, the SSBs may consume a reduced amount of overhead during the first portion of the time cycle. Additionally, the combined period 620A may be 2× the SSB period during the second portion of the time cycle. In this way, the combined overhead of the SSBs and the TRSs may be less during the first portion 605 of the time cycle than during the second portion 610 of the time cycle for the UE.

As shown in example 600B, the network node may transmit the SSBs with an SSB period 615B and with a combined period 620B that includes the SSBs and RSs transmitted between the SSBs. The SSB period 615B may be 4× an SSB period during the second portion of the time cycle. In this way, the SSBs may consume a reduced amount of overhead during the first portion of the time cycle. Additionally, the combined period 620B may be the same as the SSB period during the second portion of the time cycle. In this way, the combined overhead of the SSBs and the TRSs may be the same during the first portion 605 of the time cycle as during the second portion 610 of the time cycle for the UE of example 600B. However, the network node may conserve network resources if other UEs in the cell have a lower combined periodicity than the UE of example 600B. For example, the UE of example 600B may be at a cell edge.

As shown in example 600C, the network node may transmit the SSBs with an SSB period 615C and with a combined period 620C that includes the SSBs and RSs transmitted between the SSBs. The SSB period 615C may be 4× an SSB period during the second portion of the time cycle. In this way, the SSBs may consume a reduced amount of overhead during the first portion of the time cycle. Additionally, the combined period 620C may be 4/3× the SSB period during the second portion of the time cycle. In this way, the combined overhead of the SSBs and the TRSs may be less during the first portion 605 of the time cycle than during the second portion 610 of the time cycle for the UE.

As shown in example 600D, the network node may transmit the SSBs with an SSB period 615D and with a combined period 620D that includes the SSBs and RSs transmitted between the SSBs. The SSB period 615D may be 2× an SSB period during the second portion of the time cycle. In this way, the SSBs may consume a reduced amount of overhead during the first portion of the time cycle. Additionally, the combined period 620D may be the same as the SSB period during the second portion of the time cycle. In this way, the combined overhead of the SSBs and the TRSs may be the same during the first portion 605 of the time cycle as during the second portion 610 of the time cycle for the UE of example 600D. However, the network node may conserve network resources if other UEs in the cell have a lower combined periodicity than the UE of example 600B. For example, the UE of example 600B may be at a cell edge.

Different configurations of the SSB periods 615 may be used based at least in part on a minimum periodicity to support maintenance of the cell for UEs having a signal strength that satisfies a threshold and/or to support serving cell measurements and/or neighbor cell measurements. The combined periods 620 may be UE-specific, which may allow the network node to customize combined periods 620 to requirements of the UE and/or network conditions at the UE.

In some aspects, the first portion 605 of the time cycle may be longer than the second portion 610 of the time cycle. In other aspects, the first portion 605 of the time cycle may be shorter than the second portion 610 of the time cycle. In some aspects, the total time cycle (e.g., the first portion 605 and the second portion 610 combined) may be in a range of approximately 400 ms to approximately 10 second. The total time cycle may repeat for several time cycles.

Although shown as the first portion 605 being before the second portion 610 in time, the first portion 605 (e.g., the portion with the higher SSB periodicity) may occur after the second portion 610 in time.

As indicated above, FIG. 6 is provided as an example. Other examples may differ from what is described with respect to FIG. 6.

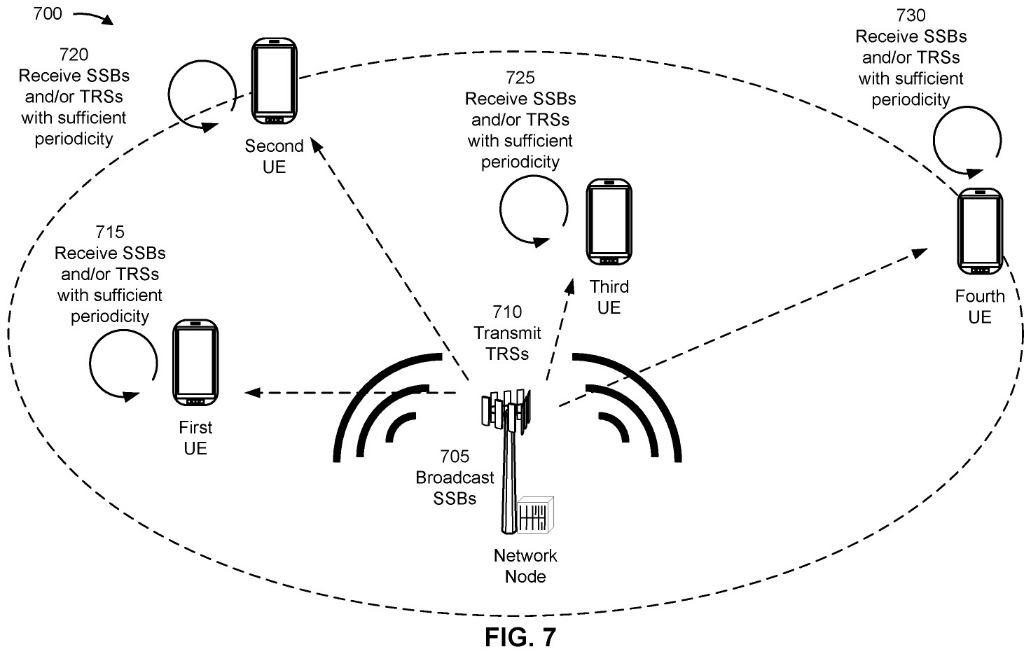

FIG. 7 is a diagram of an example 700 associated with using multiple SSB periodicities in a time cycle, in accordance with the present disclosure. As shown in FIG. 7, a network node (e.g., base station 110, a CU, a DU, and/or an RU) may communicate with UEs (e.g., UEs 120). In some aspects, the network node and the UEs may be part of a wireless network (e.g., wireless network 100). The UEs and the network node may have established wireless connections prior to operations shown in FIG. 7. In some aspects, the network node may be configured to provide the cell for a geographical area and/or for a defined distance from the network node.

As shown by reference number 705, the network node may broadcast SSBs. In some aspects, the network node may broadcast SSBs using a variable periodicity. For example, the network node may broadcast the SSBs with a first SSB periodicity during a first portion of a time cycle and with a second SSB periodicity during a second portion of the time cycle.

As shown by reference number 710, the network node may transmit TRSs to UEs for which the first periodicity is insufficient to maintain a connection in the cell.

As shown by reference number 715, a first UE may receive SSBs and/or TRSs with sufficient periodicity. For example, the first UE may have a signal strength in the cell that satisfies a threshold, which may result in the first UE receiving SSBs and not TRSs to achieve the sufficient periodicity during the first portion of the time cycle.

As shown by reference number 720, a second UE may receive SSBs and/or TRSs with sufficient periodicity. For example, the second UE may be at a cell edge and may have a signal strength in the cell that fails to satisfy a threshold, which may result in the second UE receiving SSBs and TRSs to achieve the sufficient periodicity during the first portion of the time cycle.

As shown by reference number 725, a third UE may receive SSBs and/or TRSs with sufficient periodicity. For example, the third UE may have a signal strength in the cell that satisfies a threshold, which may result in the third UE receiving SSBs and not TRSs to achieve the sufficient periodicity during the first portion of the time cycle.

As shown by reference number 730, a fourth UE may receive SSBs and/or TRSs with sufficient periodicity. For example, the fourth UE may be at a cell edge and may have a signal strength in the cell that fails to satisfy a threshold, which may result in the UE receiving SSBs and TRSs to achieve the sufficient periodicity during the first portion of the time cycle.

In some aspects, the UEs of the cell may receive TRSs with different periodicities. For example, the different periodicities may be based at least in part on capabilities of the UEs (e.g., to maintain the cell with SSBs and/or RSs) and/or signal strengths at the UEs.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with multiple SSB periodicities in a time cycle.

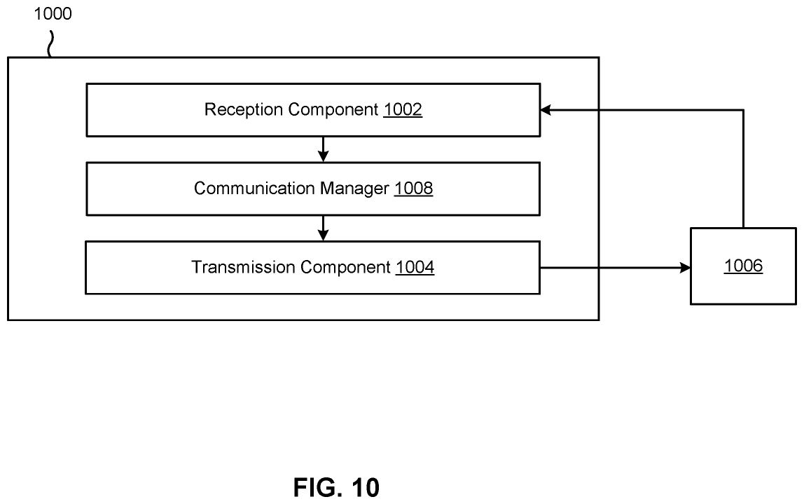

As shown in FIG. 8, in some aspects, process 800 may include receiving an indication of a configuration of SSBs for a time cycle, the configuration indicating a first SSB periodicity for a first portion of the time cycle and a second SSB periodicity for a second portion of the time cycle (block 810). For example, the UE (e.g., using communication manager 140 and/or reception component 1002, depicted in FIG. 10) may receive an indication of a configuration of SSBs for a time cycle, the configuration indicating a first SSB periodicity for a first portion of the time cycle and a second SSB periodicity for a second portion of the time cycle, as described above.

As further shown in FIG. 8, in some aspects, process 800 may include receiving multiple SSBs during the time cycle, the multiple SSBs received with the first SSB periodicity during the first portion of the time cycle and with the second SSB periodicity during the second portion of the time cycle (block 820). For example, the UE (e.g., using communication manager 140 and/or reception component 1002, depicted in FIG. 10) may receive multiple SSBs during the time cycle, the multiple SSBs received with the first SSB periodicity during the first portion of the time cycle and with the second SSB periodicity during the second portion of the time cycle, as described above.

Process 800 may include additional aspects, such as any single aspect or any combination of aspects described below and/or in connection with one or more other processes described elsewhere herein.

In a first aspect, process 800 includes transmitting an indication of a downlink SNR, wherein the indication of the downlink SNR indicates that the first SSB periodicity is insufficient for maintaining a connection to a cell, or transmitting uplink signals that support estimation of the downlink SNR.

In a second aspect, alone or in combination with the first aspect, maintaining the connection to the cell comprises one or more of synchronizing timing with the cell, synchronizing frequencies with the cell, or performing beam management.

In a third aspect, alone or in combination with one or more of the first and second aspects, process 800 includes receiving TRSs between transmissions of SSBs during the first portion of the time cycle, wherein the TRSs are configured for one or more of timing synchronization or frequency synchronization.

In a fourth aspect, alone or in combination with one or more of the first through third aspects, receiving the TRSs comprises receiving the TRSs with a periodicity of 160 ms, 80 ms, 40 ms, 20 ms, or 10 ms.

In a fifth aspect, alone or in combination with one or more of the first through fourth aspects, process 800 includes performing one or more of timing synchronization or frequency synchronization based at least in part on a combined periodicity of the multiple SSBs and the TRSs during the first portion of the time cycle.

In a sixth aspect, alone or in combination with one or more of the first through fifth aspects, the TRSs are UE-specific TRSs, and wherein the UE receives the UE-specific TRSs based at least in part on having a downlink SNR that fails to satisfy a threshold.

In a seventh aspect, alone or in combination with one or more of the first through sixth aspects, process 800 includes receiving an indication to activate the TRSs during the first portion, and receiving an indication to deactivate the TRSs during the second portion.

In an eighth aspect, alone or in combination with one or more of the first through seventh aspects, process 800 includes receiving an additional indication to deactivate the TRSs that would otherwise overlap with an SSB during the first portion, and receiving an additional indication to activate the TRSs after the SSB during the first portion.

In a ninth aspect, alone or in combination with one or more of the first through eighth aspects, a periodicity of the TRSs is based at least in part on one or more of a SNR of the UE, channeling characteristics of a channel associated with the TRSs, a capability of the UE, or scheduling constraints.

In a tenth aspect, alone or in combination with one or more of the first through ninth aspects, process 800 includes receiving multiple additional SSBs during a subsequent time cycle, the multiple additional SSBs received with the first SSB periodicity during a first portion of the subsequent time cycle and with the second SSB periodicity during a second portion of the subsequent time cycle.

In an eleventh aspect, alone or in combination with one or more of the first through tenth aspects, the second SSB periodicity is configured to support cell acquisition for one or more additional UEs at a cell edge of a cell associated with the SSBs.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., base station 110, a CU, a DU, and/or an RU) performs operations associated with multiple SSB periodicities in a time cycle.

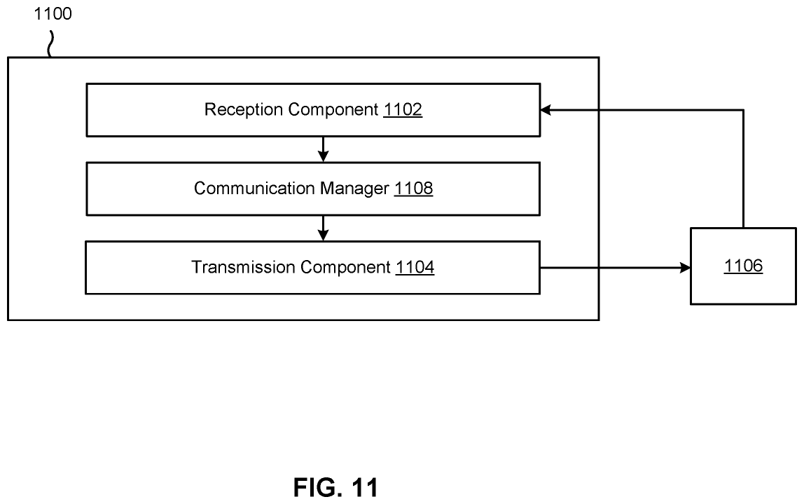

As shown in FIG. 9, in some aspects, process 900 may include transmitting an indication of a configuration of SSBs for a time cycle, the configuration indicating a first SSB periodicity for a first portion of the time cycle and a second SSB periodicity for a second portion of the time cycle (block 910). For example, the network node (e.g., using communication manager 150 and/or transmission component 1104, depicted in FIG. 11) may transmit an indication of a configuration of SSBs for a time cycle, the configuration indicating a first SSB periodicity for a first portion of the time cycle and a second SSB periodicity for a second portion of the time cycle, as described above.

As further shown in FIG. 9, in some aspects, process 900 may include transmitting multiple SSBs during the time cycle, the multiple SSBs transmitted with the first SSB periodicity during the first portion of the time cycle and with the second SSB periodicity during the second portion of the time cycle (block 920). For example, the network node (e.g., using communication manager 150 and/or transmission component 1104, depicted in FIG. 11) may transmit multiple SSBs during the time cycle, the multiple SSBs transmitted with the first SSB periodicity during the first portion of the time cycle and with the second SSB periodicity during the second portion of the time cycle, as described above.

Process 900 may include additional aspects, such as any single aspect or any combination of aspects described below and/or in connection with one or more other processes described elsewhere herein.

In a first aspect, process 900 includes identifying one or more UEs for which the first SSB periodicity is insufficient for maintaining a connection to a cell associated with the network node.

In a second aspect, alone or in combination with the first aspect, process 900 includes receiving one or more indications of downlink signal-to-noise ratios (SNRs) from the one or more UEs, wherein identification of the one or more UEs for which the first SSB periodicity is insufficient is based at least in part on the one or more indications of the SNRs from the one or more UEs, or estimating the SNRs based at least in part on one or more of uplink signals received from the one or more UEs or operational parameters for downlink communications.

In a third aspect, alone or in combination with one or more of the first and second aspects, maintaining the connection to the cell comprises one or more of synchronizing timing with the cell, synchronizing frequencies with the cell or performing beam management.

In a fourth aspect, alone or in combination with one or more of the first through third aspects, process 900 includes transmitting TRSs to one or more UEs between transmissions of SSBs during the first portion of the time cycle, wherein the TRSs are configured for one or more of timing synchronization, frequency synchronization or beam management.

In a fifth aspect, alone or in combination with one or more of the first through fourth aspects, transmitting the TRSs comprises transmitting the TRSs with a periodicity of 160 ms, 80 ms, 40 ms, 20 ms, or 10 ms.

In a sixth aspect, alone or in combination with one or more of the first through fifth aspects, process 900 includes configuring a combined periodicity of the multiple SSBs and the TRSs during the first portion of the time cycle to support timing synchronization or frequency synchronization.

In a seventh aspect, alone or in combination with one or more of the first through sixth aspects, the TRSs are UE-specific TRSs.

In an eighth aspect, alone or in combination with one or more of the first through seventh aspects, process 900 includes transmitting an indication to activate the TRSs for the one or more UEs during the first portion, and transmitting an indication to deactivate the TRSs for the one or more UEs during the second portion.

In a ninth aspect, alone or in combination with one or more of the first through eighth aspects, process 900 includes transmitting an additional indication to deactivate the TRSs that would otherwise overlap with an SSB during the first portion, and transmitting an additional indication to activate the TRSs after the SSB during the first portion.

In a tenth aspect, alone or in combination with one or more of the first through ninth aspects, periodicities of the TRSs per UE are based at least in part on one or more of SNRs of the UEs, channeling characteristics, capabilities of the UEs, or scheduling constraints.

In an eleventh aspect, alone or in combination with one or more of the first through tenth aspects, process 900 includes transmitting multiple additional SSBs during a subsequent time cycle, the multiple additional SSBs transmitted with the first SSB periodicity during a first portion of the subsequent time cycle and with the second SSB periodicity during a second portion of the subsequent time cycle.

In a twelfth aspect, alone or in combination with one or more of the first through eleventh aspects, the second SSB periodicity is configured to support cell acquisition for one or more additional UEs at a cell edge of a cell associated with the SSBs.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008 (e.g., the communication manager 140).

In some aspects, the apparatus 1000 may be configured to perform one or more operations described herein in connection with FIGS. 5-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive an indication of a configuration of SSBs for a time cycle, the configuration indicating a first SSB periodicity for a first portion of the time cycle and a second SSB periodicity for a second portion of the time cycle. The reception component 1002 may receive multiple SSBs during the time cycle, the multiple SSBs received with the first SSB periodicity during the first portion of the time cycle and with the second SSB periodicity during the second portion of the time cycle.

The transmission component 1004 may transmit an indication of a downlink SNR, wherein the indication of the downlink SNR indicates that the first SSB periodicity is insufficient for maintaining a connection to a cell.

The transmission component 1004 may transmit uplink signals that support estimation of the downlink SNR.

The reception component 1002 may receive TRSs between transmissions of SSBs during the first portion of the time cycle wherein the TRSs are configured for one or more of timing synchronization or frequency synchronization.

The communication manager 1008 may perform one or more of timing synchronization or frequency synchronization based at least in part on a combined periodicity of the multiple SSBs and the TRSs during the first portion of the time cycle.

The reception component 1002 may receive an indication to activate the TRSs during the first portion.

The reception component 1002 may receive an indication to deactivate the TRSs during the second portion.

The reception component 1002 may receive an additional indication to deactivate the TRSs that would otherwise overlap with an SSB during the first portion.

The reception component 1002 may receive an additional indication to activate the TRSs after the SSB during the first portion.

The reception component 1002 may receive multiple additional SSBs during a subsequent time cycle, the multiple additional SSBs received with the first SSB periodicity during a first portion of the subsequent time cycle and with the second SSB periodicity during a second portion of the subsequent time cycle.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a communication manager 1108 (e.g., the communication manager 150).

In some aspects, the apparatus 1100 may be configured to perform one or more operations described herein in connection with FIGS. 5-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The transmission component 1104 may transmit an indication of a configuration of SSBs for a time cycle, the configuration indicating a first SSB periodicity for a first portion of the time cycle and a second SSB periodicity for a second portion of the time cycle. The transmission component 1104 may transmit multiple SSBs during the time cycle, the multiple SSBs transmitted with the first SSB periodicity during the first portion of the time cycle and with the second SSB periodicity during the second portion of the time cycle.

The communication manager 1108 may identify one or more UEs for which the first SSB periodicity is insufficient for maintaining a connection to a cell associated with the network node.

The reception component 1102 may receive one or more indications of downlink SNRs from the one or more UEs, wherein identification of the one or more UEs for which the first SSB periodicity is insufficient is based at least in part on the one or more indications of the SNRs from the one or more UEs.

The communication manager 1108 may estimate the SNRs based at least in part on one or more of uplink signals received from the one or more UEs or operational parameters for downlink communications.

The transmission component 1104 may transmit TRSs to one or more UEs between transmissions of SSBs during the first portion of the time cycle wherein the TRSs are configured for one or more of timing synchronization, frequency synchronization or beam management.

The communication manager 1108 may configure a combined periodicity of the multiple SSBs and the TRSs during the first portion of the time cycle to support timing synchronization or frequency synchronization.

The transmission component 1104 may transmit an indication to activate the TRSs for the one or more UEs during the first portion.

The transmission component 1104 may transmit an indication to deactivate the TRSs for the one or more UEs during the second portion.

The transmission component 1104 may transmit an additional indication to deactivate the TRSs that would otherwise overlap with an SSB during the first portion.

The transmission component 1104 may transmit an additional indication to activate the TRSs after the SSB during the first portion.

The transmission component 1104 may transmit multiple additional SSBs during a subsequent time cycle, the multiple additional SSBs transmitted with the first SSB periodicity during a first portion of the subsequent time cycle and with the second SSB periodicity during a second portion of the subsequent time cycle.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving an indication of a configuration of synchronization signal blocks (SSBs) for a time cycle, the configuration indicating a first SSB periodicity for a first portion of the time cycle and a second SSB periodicity for a second portion of the time cycle; and receiving multiple SSBs during the time cycle, the multiple SSBs received with the first SSB periodicity during the first portion of the time cycle and with the second SSB periodicity during the second portion of the time cycle.

Aspect 2: The method of Aspect 1, further comprising: transmitting an indication of a downlink SNR, wherein the indication of the downlink SNR indicates that the first SSB periodicity is insufficient for maintaining a connection to a cell, or transmitting uplink signals that support estimation of the downlink SNR.

Aspect 3: The method of Aspect 2, wherein maintaining the connection to the cell comprises one or more of: synchronizing timing with the cell, synchronizing frequencies with the cell, or performing beam management.

Aspect 4: The method of any of Aspects 1-3, further comprising: receiving tracking reference signals (TRSs) between transmissions of SSBs during the first portion of the time cycle, wherein the TRSs are configured for one or more of timing synchronization or frequency synchronization.

Aspect 5: The method of Aspect 4, wherein receiving the TRSs comprises: receiving the TRSs with a periodicity of 160 milliseconds (ms), 80 ms, 40 ms, 20 ms, or 10 ms.

Aspect 6: The method of any of Aspects 4 or 5, further comprising: performing one or more of timing synchronization or frequency synchronization based at least in part on a combined periodicity of the multiple SSBs and the TRSs during the first portion of the time cycle.

Aspect 7: The method of any of Aspects 4-6, wherein the TRSs are UE-specific TRSs, and wherein the UE receives the UE-specific TRSs based at least in part on having a downlink SNR that fails to satisfy a threshold.

Aspect 8: The method of any of Aspects 4-7, further comprising: receiving an indication to activate the TRSs during the first portion; and receiving an indication to deactivate the TRSs during the second portion.

Aspect 9: The method of Aspect 8, further comprising: receiving an additional indication to deactivate the TRSs that would otherwise overlap with an SSB during the first portion: and receiving an additional indication to activate the TRSs after the SSB during the first portion.

Aspect 10: The method of any of Aspects 4-9, wherein a periodicity of the TRSs is based at least in part on one or more of: a signal-to-noise ratio (SNR) of the UE, channel characteristics of a channel associated with the TRSs, a capability of the UE, or scheduling constraints.

Aspect 11: The method of any of Aspects 1-10, further comprising: receiving multiple additional SSBs during a subsequent time cycle, the multiple additional SSBs received with the first SSB periodicity during a first portion of the subsequent time cycle and with the second SSB periodicity during a second portion of the subsequent time cycle.

Aspect 12: The method of any of Aspects 1-11, wherein the second SSB periodicity is configured to support cell acquisition for one or more additional UEs at a cell edge of a cell associated with the SSBs.

Aspect 13: A method of wireless communication performed by a network node, comprising: transmitting an indication of a configuration of synchronization signal blocks (SSBs) for a time cycle, the configuration indicating a first SSB periodicity for a first portion of the time cycle and a second SSB periodicity for a second portion of the time cycle; and transmitting multiple SSBs during the time cycle, the multiple SSBs transmitted with the first SSB periodicity during the first portion of the time cycle and with the second SSB periodicity during the second portion of the time cycle.

Aspect 14: The method of Aspect 13, further comprising: identifying one or more user equipments (UEs) for which the first SSB periodicity is insufficient for maintaining a connection to a cell associated with the network node.

Aspect 15: The method of Aspect 14, further comprising: receiving one or more indications of downlink signal-to-noise ratios (SNRs) from the one or more UEs, wherein identification of the one or more UEs for which the first SSB periodicity is insufficient is based at least in part on the one or more indications of the SNRs from the one or more UEs, or estimating the SNRs based at least in part on one or more of uplink signals received from the one or more UEs or operational parameters for downlink communications.

Aspect 16: The method of any of Aspects 14 or 15, wherein maintaining the connection to the cell comprises one or more of: synchronizing timing with the cell, synchronizing frequencies with the cell or performing beam management.

Aspect 17: The method of any of Aspects 13-16, further comprising: transmitting tracking reference signals (TRSs) to one or more user equipments (UEs) between transmissions of SSBs during the first portion of the time cycle, wherein the TRSs are configured for one or more of timing synchronization, frequency synchronization or beam management.

Aspect 18: The method of Aspect 17, wherein transmitting the TRSs comprises: transmitting the TRSs with a periodicity of 160 milliseconds (ms), 80 ms, 40 ms, 20 ms, or 10 ms.

Aspect 19: The method of any of Aspects 17 or 18, further comprising: configuring a combined periodicity of the multiple SSBs and the TRSs during the first portion of the time cycle to support timing synchronization or frequency synchronization.

Aspect 20: The method of any of Aspects 17-19, transmitting the TRSs to the one or more UEs based at least in part on the one or more UEs having downlink signal-to-noise ratios (SNRs) that fail to satisfy a threshold, wherein the TRSs are UE-specific TRSs.

Aspect 21: The method of any of Aspects 17-20, further comprising: transmitting an indication to activate the TRSs for the one or more UEs during the first portion: and transmitting an indication to deactivate the TRSs for the one or more UEs during the second portion.

Aspect 22: The method of Aspect 21, further comprising: transmitting an additional indication to deactivate the TRSs that would otherwise overlap with an SSB during the first portion: and transmitting an additional indication to activate the TRSs after the SSB during the first portion.

Aspect 23: The method of any of Aspects 17-22, wherein periodicities of the TRSs per UE are based at least in part on one or more of: signal-to-noise ratios (SNRs) of the UEs, channel characteristics, capabilities of the UEs, or scheduling constraints.

Aspect 24: The method of any of Aspects 17-23, further comprising: transmitting multiple additional SSBs during a subsequent time cycle, the multiple additional SSBs transmitted with the first SSB periodicity during a first portion of the subsequent time cycle and with the second SSB periodicity during a second portion of the subsequent time cycle.

Aspect 25: The method of any of Aspects 13-24, wherein the second SSB periodicity is configured to support cell acquisition for one or more additional UEs at a cell edge of a cell associated with the SSBs.

Aspect 26: An apparatus for wireless communication at a device, comprising a processor; memory coupled with the processor; and instructions stored in the memory and executable by the processor to cause the apparatus to perform the method of one or more of Aspects 1-25.

Aspect 27: A device for wireless communication, comprising a memory and one or more processors coupled to the memory, the one or more processors configured to perform the method of one or more of Aspects 1-25.

Aspect 28: An apparatus for wireless communication, comprising at least one means for performing the method of one or more of Aspects 1-25.

Aspect 29: A non-transitory computer-readable medium storing code for wireless communication, the code comprising instructions executable by a processor to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive an indication of a configuration of synchronization signal blocks (SSBs) for a time cycle, the configuration indicating a first SSB periodicity for a first portion of the time cycle and a second SSB periodicity for a second portion of the time cycle; and
receive multiple SSBs during the time cycle, the multiple SSBs received with the first SSB periodicity during the first portion of the time cycle and with the second SSB periodicity during the second portion of the time cycle.

2. The UE of claim 1, wherein the one or more processors are further configured to:
transmit an indication of a downlink signal-to-noise ratio (SNR), wherein the indication of the downlink SNR indicates that the first SSB periodicity is insufficient for maintaining a connection to a cell, or
transmit uplink signals that support estimation of the downlink SNR.

3. The UE of claim 2, wherein the one or more processors, to maintain the connection to the cell, are configured to:
synchronize timing with the cell,
synchronize frequencies with the cell, or
perform beam management.

4. The UE of claim 1, wherein the one or more processors are further configured to:
receive tracking reference signals (TRSs) between transmissions of SSBs during the first portion of the time cycle,
wherein the TRSs are configured for one or more of timing synchronization or frequency synchronization.

5. The UE of claim 4, wherein the one or more processors, to receive the TRSs, are configured to:
receive the TRSs with a periodicity of 160 milliseconds (ms), 80 ms, 40 ms, 20 ms, or 10 ms.

6. The UE of claim 4, wherein the one or more processors are further configured to:
perform one or more of timing synchronization or frequency synchronization based at least in part on a combined periodicity of the multiple SSBs and the TRSs during the first portion of the time cycle.

7. The UE of claim 4, wherein the TRSs are UE-specific TRSs, and
wherein the UE receives the UE-specific TRSs based at least in part on having a downlink signal-to-noise ratio (SNR) that fails to satisfy a threshold.

8. The UE of claim 4, wherein the one or more processors are further configured to:
receive an indication to activate the TRSs during the first portion; and
receive an indication to deactivate the TRSs during the second portion.

9. The UE of claim 8, wherein the one or more processors are further configured to:
receive an additional indication to deactivate the TRSs that would otherwise overlap with an SSB during the first portion; and
receive an additional indication to activate the TRSs after the SSB during the first portion.

10. The UE of claim 4, wherein a periodicity of the TRSs is based at least in part on one or more of:
a signal-to-noise ratio (SNR) of the UE,
channel characteristics of a channel associated with the TRSs,
a capability of the UE, or
scheduling constraints.

11. The UE of claim 1, wherein the one or more processors are further configured to:
receive multiple additional SSBs during a subsequent time cycle, the multiple additional SSBs received with the first SSB periodicity during a first portion of the subsequent time cycle and with the second SSB periodicity during a second portion of the subsequent time cycle.

12. The UE of claim 1, wherein the second SSB periodicity is configured to support cell acquisition for one or more additional UEs at a cell edge of a cell associated with the SSBs.

13. A network node for wireless communication, comprising:
a memory; and
one or more processors, coupled to the memory, configured to:
transmit an indication of a configuration of synchronization signal blocks (SSBs) for a time cycle, the configuration indicating a first SSB periodicity for a first portion of the time cycle and a second SSB periodicity for a second portion of the time cycle; and
transmit multiple SSBs during the time cycle, the multiple SSBs transmitted with the first SSB periodicity during the first portion of the time cycle and with the second SSB periodicity during the second portion of the time cycle.

14. The network node of claim 13, wherein the one or more processors are further configured to:
identify one or more user equipments (UEs) for which the first SSB periodicity is insufficient for maintaining a connection to a cell associated with the network node.

15. The network node of claim 14, wherein the one or more processors are further configured to:
receive one or more indications of downlink signal-to-noise ratios (SNRs) from the one or more UEs, wherein identification of the one or more UEs for which the first SSB periodicity is insufficient is based at least in part on the one or more indications of the SNRs from the one or more UEs, or
estimate the SNRs based at least in part on one or more of uplink signals received from the one or more UEs or operational parameters for downlink communications.

16. The network node of claim 14, wherein the one or more processors, to maintain the connection to the cell, are configured to:
synchronize timing with the cell,
synchronize frequencies with the cell or
perform beam management.

17. The network node of claim 13, wherein the one or more processors are further configured to:
transmit tracking reference signals (TRSs) to one or more user equipments (UEs) between transmissions of SSBs during the first portion of the time cycle,
wherein the TRSs are configured for one or more of timing synchronization, frequency synchronization or beam management.

18. The network node of claim 17, wherein the one or more processors, to transmit the TRSs, are configured to:
transmit the TRSs with a periodicity of 160 milliseconds (ms), 80 ms, 40 ms, 20 ms, or 10 ms.

19. The network node of claim 17, wherein the one or more processors are further configured to:
configure a combined periodicity of the multiple SSBs and the TRSs during the first portion of the time cycle to support timing synchronization or frequency synchronization.

20. The network node of claim 17, transmitting the TRSs to the one or more UEs based at least in part on the one or more UEs having downlink signal-to-noise ratios (SNRs) that fail to satisfy a threshold,
wherein the TRSs are UE-specific TRSs.

21. The network node of claim 17, wherein the one or more processors are further configured to:
transmit an indication to activate the TRSs for the one or more UEs during the first portion; and
transmit an indication to deactivate the TRSs for the one or more UEs during the second portion.

22. The network node of claim 21, wherein the one or more processors are further configured to:
transmit an additional indication to deactivate the TRSs that would otherwise overlap with an SSB during the first portion; and
transmit an additional indication to activate the TRSs after the SSB during the first portion.

23. The network node of claim 17, wherein periodicities of the TRSs per UE are based at least in part on one or more of:
signal-to-noise ratios (SNRs) of the UEs,
channel characteristics,
capabilities of the UEs, or
scheduling constraints.

24. The network node of claim 17, wherein the one or more processors are further configured to:
transmit multiple additional SSBs during a subsequent time cycle, the multiple additional SSBs transmitted with the first SSB periodicity during a first portion of the subsequent time cycle and with the second SSB periodicity during a second portion of the subsequent time cycle.

25. The network node of claim 13, wherein the second SSB periodicity is configured to support cell acquisition for one or more additional UEs at a cell edge of a cell associated with the SSBs.

26. A method of wireless communication performed by a user equipment (UE), comprising:
receiving an indication of a configuration of synchronization signal blocks (SSBs) for a time cycle, the configuration indicating a first SSB periodicity for a first portion of the time cycle and a second SSB periodicity for a second portion of the time cycle; and
receiving multiple SSBs during the time cycle, the multiple SSBs received with the first SSB periodicity during the first portion of the time cycle and with the second SSB periodicity during the second portion of the time cycle.

27. The method of claim 26, further comprising:
receiving tracking reference signals (TRSs) between transmissions of SSBs during the first portion of the time cycle,
wherein the TRSs are configured for one or more of timing synchronization or frequency synchronization.

28. The method of claim 27, further comprising:
performing one or more of timing synchronization or frequency synchronization based at least in part on a combined periodicity of the multiple SSBs and the TRSs during the first portion of the time cycle.

29. A method of wireless communication performed by a network node, comprising:
transmitting an indication of a configuration of synchronization signal blocks (SSBs) for a time cycle, the configuration indicating a first SSB periodicity for a first portion of the time cycle and a second SSB periodicity for a second portion of the time cycle; and
transmitting multiple SSBs during the time cycle, the multiple SSBs transmitted with the first SSB periodicity during the first portion of the time cycle and with the second SSB periodicity during the second portion of the time cycle.

30. The method of claim 29, further comprising:
transmitting tracking reference signals (TRSs) to one or more user equipments (UEs) between transmissions of SSBs during the first portion of the time cycle,
wherein the TRSs are configured for one or more of timing synchronization, frequency synchronization or beam management.
